(19) United States
(12) Patent Application Publication
(10) Pub. No.: US 2021/0178690 A1
(43) Pub. Date: Jun. 17, 2021

(54) PRINTING SYSTEM GUIDE RAIL CLEANING ASSEMBLY

(71) Applicant: HEWLETT-PACKARD DEVELOPMENT COMPANY, L.P., Houston, TX (US)

(72) Inventors: Matt G. DRIGGERS, Vancouver, WA (US); John MEANS, Vancouver, WA (US)

(73) Assignee: HEWLETT-PACKARD DEVELOPMENT COMPANY, L.P., Houston, TX (US)

(21) Appl. No.: 16/077,088

(22) PCT Filed: Jul. 28, 2017
(86) PCT No.: PCT/US2017/044424

§ 371 Date: Aug. 10, 2018

(51) Int. Cl. B29C 64/35; B33Y 30/00; B33Y 40/00; B29C 64/227; B22F 12/00; B28B 1/00

(52) U.S. Cl. CPC B29C 64/35; B33Y 30/00; B28B 1/001; B29C 64/227; B22F 12/22; B33Y 40/00

(57) ABSTRACT

According to examples, a printing system may include a guide rail and a carriage. The carriage may include a rotatable member supported on the guide rail. The printing system may also include a cleaning assembly mounted to the carriage and the cleaning assembly may have a scraper to scrape debris off at least a portion of the guide rail.

### BACKGROUND

In three-dimensional (3D) printing, an additive printing process is often used to make three-dimensional solid parts from a digital model. Some 3D printing techniques are considered additive processes because they involve the application of successive layers or volumes of a build material, such as a powder or powder-like build material, to an existing surface (or previous layer). Particulates of the build material may contaminate various surfaces of components, which may cause defects in the printing of 3D objects.

### BRIEF DESCRIPTION OF THE DRAWINGS

Features of the present disclosure are illustrated by way of example and not limited in the following figure(s), in which like numerals indicate like elements, in which:

FIG. 1A shows a front view of an example printing system that may include example cleaning assemblies;

FIGS. 1B and 1C, respectively, show side views of the example printing system depicted in FIG. 1A having other example cleaning assemblies;

FIG. 1D depicts an enlarged view of a scraper and a mounting member of the scraper assemblies depicted in FIGS. 1A-1C according to one example;

FIG. 2 shows a side perspective view of an example cleaning assembly and a rotatable member shown in FIGS. 1A and 1B,

FIG. 3A shows a top perspective view of another cleaning assembly that may be mounted to a portion of a chassis of a carriage in a printing system according to one example; and

FIG. 3B shows a bottom perspective view of the example cleaning assembly depicted in FIG. 3A and a portion of the chassis.

### DETAILED DESCRIPTION

In powder-based three-dimensional (3D) printing systems, successive layers of a build material, such as a powder or powder-type build material, may be formed, for example, on a build platform. Portions of each layer may be selectively solidified, with each portion representing a portion of a 3D object to be formed. In some examples, a build material may include a powdered build material that is composed of particles in the form of fine powder or granules. In addition or in other examples, the build material may include short fibers. In any regard, the powdered build material may include metal particles, plastic particles, polymer particles, ceramic particles, or particles of other materials.

The 3D printing systems may include various components that may be moved, for instance, over the build platform to create the successive layers and to selectively solidify the portions of the layers. For instance, a carriage supporting printing components such as a printhead, a recoater, a heat lamp, or the like, may be scanned across the build platform during printing and other operations. The carriage may include rotatable members that are supported on a guide rail or on multiple guide rails such that the rotatable members rotate as the carriage is scanned. In many instances, particulates of the build material powder may become airborne due to environmental and/or printing processes and may contaminate various surfaces of the 3D printing systems, including the rotatable members, the guide rail or rails, upon which the carriage rolls.

Contamination of the guide rail or rails may interfere with the contact between the rotatable members and the guide rail(s), which may cause defects in the formation of 3-D objects. For instance, debris on the guide rail(s) and/or the rotatable members may prevent build material particles from being applied in a smooth, level layer. As another example, the debris may interfere with the accurate positioning of the carriage with respect to the build platform, which may result in, for instance, deposition of printing liquid in unintended locations. Similar types of errors due to debris, such as dust, and other airborne particulates, may also occur in two-dimensional (2D) printing systems that employ a carriage and a guide rail or guide rails.

Disclosed herein are cleaning assemblies that may be mounted to a carriage of a printing system as well as carriages and printing systems upon which the cleaning assemblies may be mounted. The cleaning assemblies disclosed herein may include a scraper to clean debris off of at least a portion of a guide rail as the carriage is scanned over the guide rail. The cleaning assemblies disclosed herein may also include a brush to further clean debris off at least a portion of the guide rail. In addition, or in other examples, the cleaning assemblies may include a scraper and/or a brush to clear off debris from at least a portion of a rotatable member upon which the carriage is supported on a guide rail.

Through implementation of the cleaning assemblies disclosed herein, debris may be cleared off at least a portion of a guide rail and/or a rotatable member simply by moving a carriage over the guide rail. As such, for instance, the guide rail and/or rotatable member may continuously be cleaned during printing operations and thus, a separate cleaning operation may not implemented to clean the guide rail. In one regard, therefore, the number of defects caused by contamination on guide rails and/or rotatable members may be reduced or minimized.

Before continuing, it is noted that as used herein, the terms “includes” and “including” mean, but are not limited to, “includes” or “including” and “includes at least” or “including at least.” The term “based on” means, but is not limited to, “based on” and “based at least in part on.”

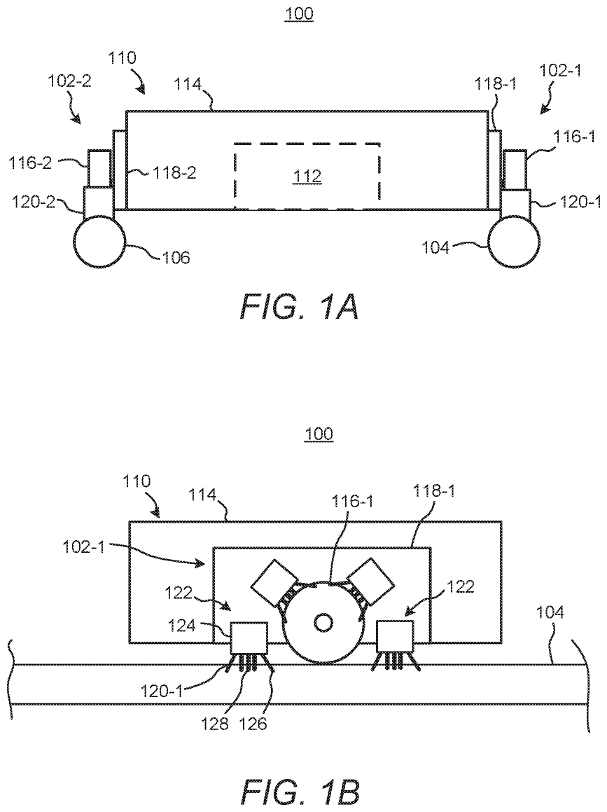

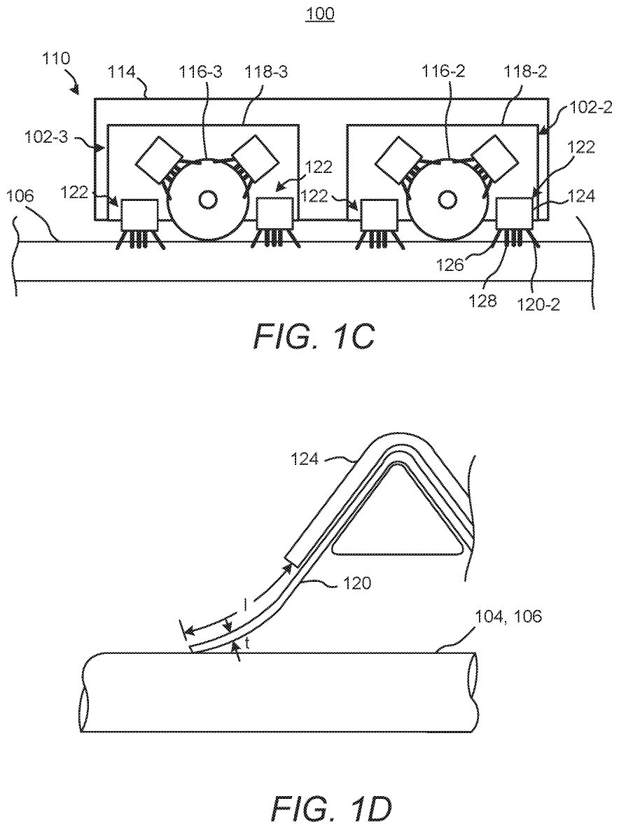

Reference is first made to FIGS. 1A-1C. FIG. 1A shows a front view of an example printing system 100 that may include example cleaning assemblies 102. FIGS. 1B and 10, respectively, show side views of the example printing system 100 depicted in FIG. 1A having other example cleaning assemblies 102. It should be understood that the printing system 100 and the cleaning assemblies 102 depicted in FIGS. 1A-1C may include additional components and that some of the components described herein may be removed and/or modified without departing from a scope of the printing system 100 disclosed herein. In addition, it should be understood that the components of the printing system 100 may not be drawn to scale and that the components may thus have different respective sizes without departing from a scope of the printing system 100 disclosed herein.

The printing system 100 depicted in FIGS. 1A-1C may be a portion of a three-dimensional (3D) printing system or a portion of a two-dimensional (2D) printing system. In examples in which the printing system 100 is a 3D printing system, the printing system 100 may form 3D objects from layers of build material particles, which may be in powder or power-like form. The printing system 100 may also form 3D objects from other types of materials in other examples. In examples in which the printing system 100 is a 2D printing system, the printing system 100 may print marking material, such as ink, onto media, such as paper.

The printing system 100 may include a first guide rail 104 and a second guide rail 106, although in some examples, the printing system 100 may include a single guide rail 104 or more than two guide rails 104, 106. The printing system 100 may also include a carriage 110 that may be scanned across a build area (3D printing system) or a print area (2D printing system) along the first and second guide rails 104, 106, which may also be termed herein as rails 104, 106. The build area may generally be defined as an area of the printing system 100 at which 3D objects may be formed from the build material particles. Likewise, the print area may generally be defined as an area of the printing system 100 at which media may be printed upon.

The first and second guide rails 104, 106 may extend across a portion of or over the entire build/print area of the printing system 100. The carriage 110 may include a chassis 114 on which rotatable members 116-1 to 116-3, which are collectively referenced herein as rotatable members 116 (or equivalently, spinning members 116), may rotatably be mounted and which may be supported on the first and second guide rails 104, 106. As shown, a first rotatable member 116-1 (which may also be referenced herein as a first spinning member 116-1), may be rotatably mounted to a first side of the chassis 114. As also shown, a second rotatable member 116-2 and a third rotatable member 116-3 may rotatably be mounted to a second side of the chassis 114.

The rotatable members 116, which may be wheels, bearings, rollers, or the like, may be formed of any suitable material, such as rubber, metal, plastic, or the like. In addition, the rotatable members 116 may rotatably be mounted to the chassis 114 through respective axles.

In addition, the carriage 110 may support a printing system component 112 (shown in dashed lines) that may be controlled to perform an action as the carriage 110 is scanned over the build area or print area on the first and second guide rails 104, 106. The printing system component 112 may be any combination of a printhead to deliver a fusing agent and/or a marking material onto the build material particles/media, a heating lamp to apply heat onto the build material particles/media, a recoater to spread layers of build material particles across the build area (e.g., a build platform), multiple ones of these components, etc. In this regard, the actions may include any of the actions that the above-identified printing system components 112 may perform.

Although not shown, the chassis 114 may be attached to a belt, chain, rod, or other implement that may push or pull the chassis 114 across the build/print area of the printing system 100. The rotatable members 116 may rotate as the carriage 110 is moved over the guide rails 104, 106. During operation, debris, such as build material particles, dust, particulates, etc., may contaminate the guide rails 104, 106, as well as other components in the printing system 100, such as the rotatable members 116. The contamination of the guide rails 104, 106 (and the rotatable members 116) may interfere with the contact between the rotatable members 116 and the guide rails 104, 106, which may cause defects in the formation of 3-D objects, printed media, etc. For instance, debris on the guide rails 104, 106 and/or the rotatable members 116 may prevent build material particles from being applied in a smooth, level layer. As another example, the debris may interfere with the accurate positioning of the carriage 110 with respect to the build area/print area, which may result in, for instance, deposition of printing liquid in unintended locations.

According to examples, cleaning assemblies 102-1 to 102-3, which are collectively referenced herein as cleaning assemblies 102, may be mounted on opposite sides of the carriage 110 to clean debris off at least portions of the guide rails 104, 106 as the carriage 110 is scanned across the guide rales 104, 106. Each of the cleaning assemblies 102 may include a plate 118 and a scraper 120. The scrapers 120 may be attached to respective plates 118 and the plates 118 may be mounted to respective sides of the chassis 114. In other examples, the scrapers 120 may be mounted directly to the chassis 114 without the plates 118. In any regard, a first scraper 120-1 may contact a portion of a surface of the first guide rail 104 and a second scraper 120-2 may contact a portion of a surface of the second guide rail 106. The sections of the scrapers 120 that contact the portions of the surfaces of the guide rails 104, 106 may be contoured to match or complement the shape of the guide rails 104, 106.

The scrapers 120 may be formed of a material that is durable, low friction, able to withstand relatively high temperatures, etc. For instance, the scrapers 120 may be formed of plastic, such as polyimide, metal, such as brass, bronze, stainless steel, etc., or the like. The scrapers 120 may also be formed of a combination of materials. For instance, the scrapers 120 may have base sections and contact sections, in which the base sections may be formed of a relatively more rigid material than the contact sections that are to contact the guide rails 104, 106. In these examples, the base sections may be cantilevered from the plates 118 and the contact sections may extend from the base sections to contact the guide rails 104, 106.

The scrapers 120 may be angled with respect to the guide rails 104, 106 such that the scrapers function to plow or bulldoze across the guide rails 104, 106 as the carriage 110 is moved. By way of example, the chassis 114 may extend along a first axis, e.g., a horizontal axis, and the first scraper 120-1 may be angled between about 181 and about 269 degrees with respect to the first axis when in contact with the first support rail 104. By way of particular example, the first scraper 120-1 may be between about 200 and about 230 degrees with respect to the first axis when in contact with the first support rail 104. In addition, the second scraper 120-2 may be between about 271 and about 359 degrees with respect to the first axis when in contact with the second support rail 106. By way of particular example, the second scraper 120-2 may be between about 290 and about 330 degrees with respect to the first axis when in contact with the second support rail 106. When not in contact with the guide rails 104, 106, the scrapers 120 may have different angles. As such, for instance, placement of the scrapers 120 into contact with the guide rails 104, 106 may result in the scrapers 120 bending to a greater extent.

In addition, or in other examples, the scrapers 120 may be curved prior to being positioned into contact and/or due to contact with the guide rails 104, 106. The scrapers 120 may maintain the curved shape as the scrapers 120 scrape the surfaces of the guide rails 104, 106 to thus remove debris that may have collected on the surfaces of the guide rails 104, 106 upon which the rotatable members 116 contact. That is the curvature in the scrapers 120 may facilitate the removal of the debris from the guide rails 104, 106.

As shown in FIGS. 1B and 10, the scrapers 120 may be parts of respective scraper assemblies 122, which may also include mounting members 124 to which the scrapers 120 are respectively attached and/or inserted. In addition, the mounting member 126 may be mounted to the plates 118 or directly to the chassis 114. As shown, the mounting members 124 may house or support respective complementary scrapers 126 that may be positioned on opposite sides of the mounting members 124 with respect to the scrapers 120. The complementary scrapers 126 may be positioned adjacent to a respective scraper 120 and the angles of the complementary scrapers 126 may have angles that are opposite the angles of the scrapers 120 attached to the respective mounting members 124. In this regard, the complementary scrapers 126 may scrape the guide rails 104, 106 to remove debris as the carriage 110 is moved in a direction opposite the direction at which the scrapers 120 scrape the guide rails 104, 106 to remove debris. The complementary scrapers 126 may be formed of the same materials as the scrapers 120. In some examples, the complementary scrapers 126 may be formed of respective unitary pieces of material with the scrapers 120. In these examples, for instance, a unitary piece of material may be formed into a V-shape to form a scraper 120 and a complementary scraper 126 and may be inserted into a mounting member 124, for instance, as shown in FIG. 1D.

With particular reference to FIG. 1D, which depicts an enlarged view of a scraper 120 and a mounting member 124 of the scraper assemblies 122 according to an example, the scraper 120 may have an unsupported (or exposed) length, l, and a thickness, t. According to examples, the length, l, and/or the thickness, t, of the scraper 120 may be varied to adjust the force and contact angle of the scraper 120 on a guide rail 104, 106. In this regard, by selecting scrapers 120 with different unsupported lengths and/or thicknesses, the amount of force and the contact angle of the scrapers 120 may be optimized for particular applications.

The scraper assemblies 122 may also include brushes 128 attached to the mounting members 124. The brushes 128 may be formed of a material similar to those discussed above with respect to the scrapers 120. In addition, the brushes 128 may be positioned to be in contact with the guide rails 104, 106 to also brush debris off at least portions of the guide rails 104, 106. As shown, the brushes 128 may be positioned between respective sets of scrapers 120 and complementary scrapers 126. However, in other examples, the brushes 128 may be positioned outside of the scrapers 120 and/or the complementary scrapers 126.

As also shown in FIGS. 1B and 10, additional scraper assemblies 122 may be positioned at multiple locations with respect to the rotatable members 116. For instance, scraper assemblies 122 may be positioned on opposite sides of the first rotatable member 116-1, on opposite sides of the second rotatable member 116-2, and on opposite sides of the third rotatable member 116-3. Scraper assemblies 122 may additionally be positioned at other locations with respect to the rotatable members 116. For instance, scraper assemblies 122 may be positioned to scrape the surfaces of the rotatable members 116 that contact the guide rails 104, 106. In this regard, some of the scraper assemblies 122 may include rotatable member scrapers 120 and/or rotatable member brushes 128 to be implemented to remove debris from the rotatable members 116.

Although particular reference is made herein to the printing system 100 including both the first guide rail 104 and the second guide rail 106, in some examples, the printing system 100 may include a single guide rail 104 without departing from a scope of the printing system 100 disclosed herein. In these examples, the carriage 110 may be supported on the single guide rail 104, on the guide rail 104 and another surface, on the guide rail 104 and another structure, or the like. In other examples, the printing system 100 may include both guide rails 104, 106, but the carriage 110 may be supported on one of the guide rails 104 and/or the carriage 110 may be supported on both guide rails 104, 106, but a cleaning assembly 102 may be provided to clean one of the guide rails 104.

In addition or in other examples, although the guide rails 104, 106 have been depicted as having circular cross-sections, it should be understood that the guide rails 104, 106 may have cross-sections having other geometrical shapes. For instance, the guide rails 104, 106 may have square, rectangular, triangular, combinations thereof, etc., shaped cross sections. Moreover, the first guide rail 104 may have a different cross-section and/or size than the second guide rail 106.

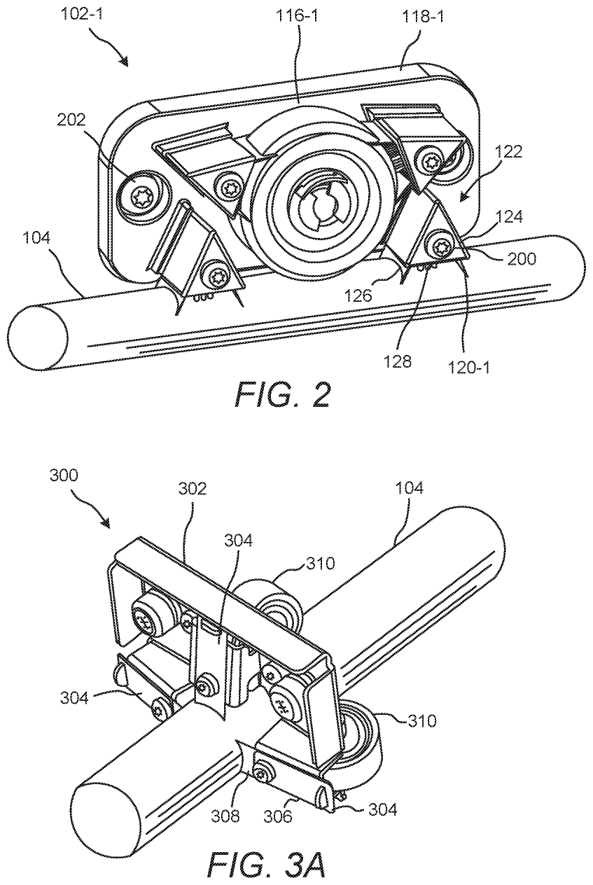

Turning now to FIG. 2, there is shown a side perspective view of an example cleaning assembly 102-1 and a rotatable member 116-1 shown in FIGS. 1A and 1B. The cleaning assemblies 102-2 and 102-3 may have similar configurations. As shown, the scrapers 120-1, 126 and the brushes 128 may be mounted to the scraper assemblies 122 and the scraper assemblies 122 may be mounted to the plate 118-1 via mechanical fasteners 200. In addition, the plate 118-1 may be mounted to the chassis 114 of the carriage 110 via mechanical fasteners 202. In other examples, however, the scraper assemblies 122 may be mounted to the plate 118-1 and the plate 118-1 may be mounted to the chassis 114 via other mechanisms, such as welds, glue, etc.

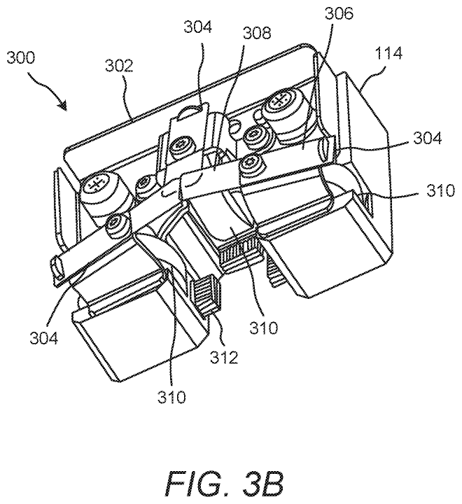

Reference is now made to FIGS. 3A and 3B. FIG. 3A shows a top perspective view of another cleaning assembly 300 that may be mounted to a portion of a chassis 114 of a carriage 110 in a printing system 100. FIG. 3B shows a bottom perspective view of the example cleaning assembly 300 depicted in FIG. 3A and a portion of the chassis 114. It should be understood that the cleaning assembly 300 depicted in FIGS. 3A and 3B may include additional components and that some of the components described herein may be removed and/or modified without departing from a scope of the cleaning assembly 300 disclosed herein. In addition, it should be understood that the components of the cleaning assembly 300 may not be drawn to scale and that the components may thus have different respective sizes without departing from a scope of the cleaning assembly 300 disclosed herein.

The cleaning assembly 300 may include a plate 302 that may be attached to a chassis 114. The cleaning assembly 300 may also include a plurality of scrapers 304 attached to the plate 302. Each of the scrapers 304 may be formed of a base portion 306 and a contact portion 308, in which the base portion 306 may be formed of a relatively more rigid material as compared with the contact portion 308. In addition, the scrapers 304 may be formed of materials similar to those discussed above with respect to the scrapers 120.

As shown, the scrapers 304 may contact different sections of a guide rail 104 and may be aligned with respective rotatable members 310. In addition, each of the contact portions 308 of the scrapers 304 may extend toward a common position with respect to the cleaning assembly 300, e.g., a central axis of the guide rail. The rotatable members 310 may be similar to the rotatable members 116 discussed above with respect to FIGS. 1A-1C and may be rotatably mounted to a chassis 114. In addition, similarly to the rotatable members 116, the rotatable members 306 may rotate as the carriage 110 is moved with respect to the guide rail 104.

In any regard, the scrapers 304, and more particularly, the contact portions 308 may contact different sections of the guide rail 104 and may scrape debris off or remove debris from at least a portion of the guide rail 104 as the carriage 110 is moved with respect to the guide rail 104. The scraper assembly 300 may also include brushes 312 that may additionally clean debris off at least a portion of the guide rail 104. Although the brushes 312 are depicted as being mounted to the chassis 114, it should be understood that the brushes 312 may instead be attached to the plate 302 without departing from a scope of the cleaning assembly 300. Additionally, scrapers and/or brushes may be positioned to clear debris from the rotatable members 310.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A printing system comprising:
a guide rail;
a carriage having a rotatable member supported on the guide rail; and
a cleaning assembly mounted to the carriage, the cleaning assembly having a scraper to scrape debris off at least a portion of the guide rail.

2. The printing system according to claim 1, wherein the scraper is positioned adjacent to the rotatable member.

3. The printing system according to claim 1, wherein the cleaning assembly further includes a complementary scraper to scrape debris off at least a portion of the guide rail, wherein the scraper is positioned adjacent to a first side of the rotatable member and the complementary scraper is positioned adjacent to a second side of the rotatable member.

4. The printing system according to claim 1, wherein the guide rail extends along a first direction and wherein the scraper is positioned at an angle with respect to the first direction that is less than perpendicular to the first direction.

5. The printing system according to claim 1, wherein the scraper is formed into a V-shape including a first section and a second section, the first section extending at a first angle with respect to the guide rail and the second section extending at a second angle with respect to the guide rail.

6. The printing system according to claim 1, wherein the cleaning assembly further includes a rotatable member scraper and a rotatable member brush to remove debris from the rotatable member.

7. The printing system according to claim 1, wherein the cleaning assembly further includes a brush to clear debris off at least a portion of the guide rail.

8. The printing system according to claim 1, wherein the carriage supports a printhead, a heating lamp, a recoater to spread layers of build material particles over a build platform, or a combination thereof.

9. A carriage comprising:
a chassis;
a spinning member rotatably mounted on the chassis, wherein the spinning member is to support the chassis on a support rail and the spinning member is to traverse the support rail; and
a scraper mounted to the chassis and positioned to scrape debris off at least a portion of the support rail as the chassis is translated on the support rail.

10. The carriage according to claim 9, wherein the scraper is positioned adjacent to a first side of the spinning member, the carriage further comprising:
a complementary scraper positioned adjacent to a second side of the spinning member.

11. The carriage according to claim 9, further comprising:
a second scraper; and
a third scraper, wherein each of the scraper, the second scraper, and the third scraper has a contact portion and wherein each of the contact portions extend toward a common position with respect to the cleaning assembly.

12. The carriage according to claim 9, further comprising a rotatable member scraper and a rotatable member brush to remove debris off at least a portion of the spinning member during rotation of the spinning member.

13. The carriage according to claim 9, further comprising:
a printhead, a heating lamp, a recoater to spread layers of build material particles over a build platform, or a combination thereof.

14. A printing system comprising:
a first rail;
a second rail;
a carriage having:
a chassis supporting a printhead;
a first member rotatably mounted to the chassis; and
a second member rotatably mounted to the chassis, wherein the carriage is translatable on the first guide rail and the second guide rail via the first member and the second member respectively;
a cleaning assembly mounted to the chassis, the cleaning assembly having:
a first scraper to scrape debris off at least a portion of the first guide rail, the first scraper being positioned at a first angle with respect to the first guide rail; and
a second scraper to scrape debris off at least a portion of the second guide rail, the second scraper being positioned a second angle with respect to the second guide rail.

15. The printing system according to claim 14, the cleaning assembly further comprising:
a first brush to clear debris off at least a portion of the first guide rail;
a second brush to clear debris off at least a portion of the second guide rail; and
a first member scraper to scrape debris off at least a portion of the first member.
